(19) United States
(12) Patent Application Publication
(10) Pub. No.: US 2020/0320623 A1
(43) Pub. Date: Oct. 8, 2020

(54) SYSTEM AND METHOD FOR TRADING A TRADABLE OBJECT

(71) Applicant: Alan McGrath, Las Vegas, NV (US)

(72) Inventor: Alan McGrath, Las Vegas, NV (US)

(21) Appl. No.: 16/841,455

(22) Filed: Apr. 6, 2020

Related U.S. Application Data
(60) Provisional application No. 62/829,651, filed on Apr. 5, 2019.

(51) Int. Cl. G06Q 40/04; G06Q 20/22; G06Q 50/18; G06Q 40/02; G06F 16/11; H04L 29/08

(52) U.S. Cl. CPC G06Q 40/04; G06Q 20/223; G06Q 50/188; G06Q 50/01; G06F 16/113; H04L 67/104; G06Q 40/02

(57) ABSTRACT

A system and method for electronically trading a tradable object by remote traders is presently provided. At least one trading desk is operated by a tenant and is hosted on a trading platform. One or more remote traders may make offers, accept offers, and negotiate trades on the trading desk.

### CROSS REFERENCE TO RELATED APPLICATION

This application claims the benefit of and priority to U.S. Provisional Patent Application No. 62/829,651, filed Apr. 5, 2019, the entire content of which is incorporated herein by reference in its entirety.

### FIELD OF INVENTION

The present invention relates to electronic systems and methods for trading tradable objects.

### BACKGROUND OF THE INVENTION

Tangible and intangible objects are continually electronically traded worldwide. An example of an intangible object that is electronically traded is a virtual currency. A virtual currency is issued and often controlled by its developers, and may be used and accepted among the members of a specific virtual community. The US Department of Treasury defines virtual currency as “a medium of exchange that operates like a currency in some environments, but does not have all the attributes of real currency”.

Digital currency is a form of virtual currency or medium of exchange that is electronically created and stored. Some digital currencies are cryptocurrencies, for example Bitcoin, others are not, for example the Ven. Like traditional money, for example USD, these currencies may be used to buy physical goods and services. The virtual currency may be decentralized, for example Bitcoin. A decentralized currency is defined by the US Department of Treasury as a “currency (1) that has no central repository and no single administrator, and (2) that persons may obtain by their own computing or manufacturing effort”. Trust in the currency is based on the “transaction ledger which is cryptographically verified, and jointly maintained by the currency's users”.

Bitcoins are an example of a tradable object that may be traded with the presently disclosed system and method. Bitcoins are created by a process called mining, in which computer network participants, i.e., users who provide their computing power, verify and record payments into a public ledger in exchange for transaction fees and newly minted bitcoins. Users send and receive bitcoins using wallet software on a personal computer, mobile device, or a web application. Bitcoins can be obtained by mining or in exchange for products, services, or other currencies. Where people are allowed to buy in bitcoins, prices are denominated in fiat currency and the amount of bitcoins paid is determined by the prevailing exchange rate.

Currently, methods and systems for electronically trading tradable objects may lack desired security and oversight. This may result in a lack of trust of traders when trading a virtual currency for a tangible or intangible object.

### SUMMARY OF THE INVENTION

One aspect of the present disclosure provides a method of trading a tradable object by using non-transitory computer-readable medium capable of execution by an electronic computing device, the method comprising the steps of: receiving, by a first remote trader at a first computing device, market data related to a tradable object on a trading desk; displaying, on the first computing device, the market data and a trading interface on the trading desk; receiving, by a second remote trader at a second computing device, market data related to the tradable object on the trading desk; displaying, on the second computing device, the market data and the trading interface on the trading desk; making an offer to buy or sell the tradable object, by the first remote trader or the second remote trader, on the trading desk; selecting the offer to buy or sell the tradable object, by the other of the first remote trader and the second remote trader, on the trading desk; automatically establishing a peer-to-peer trading room and notifying an administrator of the selection of the offer to buy or sell the tradable object, the identity of the first remote trader, and the identity of the second remote trader, and the establishment of the peer-to-peer trading room; notifying the first remote trader and the second remote trader of the establishment of the peer-to-peer trading room and enabling the first remote trader and the second remote trader to join the peer-to-peer trading room; blocking communications in the peer-to-peer trading room until the administrator has joined the peer-to-peer trading room; upon the administrator joining the peer-to-peer trading room, unblocking communications in the peer-to-peer trading room, enabling communications in the peer-to-peer trading room, and sending a notification to the first remote trader and the second remote trader, notifying each of their ability to communicate in the peer-to-peer trading room; negotiating terms of the trade of the tradable object in the peer-to-peer trading room, by the first remote trader and the second remote trader, after their receipt of the notification of their ability to communicate in the peer-to-peer trading room; monitoring and facilitating the negotiations between the first remote trader and the second remote trader, by the administrator in the peer-to-peer trading room; agreeing upon an asset type of the tradable object and terms of the trade, by the first remote trader and the second remote trader; notifying the first remote trader and the second remote trader of the agreed upon asset type and the terms of the trade, by the administrator in the peer-to-peer trading room, upon the first remote trader, the second remote trader, and the administrator being simultaneously joined and present in the peer-to-peer trading room, locking in an asset type of the tradable object that is being traded and the agreed upon terms of the trade; notifying the first remote trader and the second remote trader of the locked in asset type and the agreed upon terms of the trade, by the administrator in the peer-to-peer trading room; and closing the peer-to-peer trading room.

Another aspect of the present disclosure provides a trading system for use by remote traders in making trades of tradable objects, the trading system comprising: a trading desk; a first electronic communication device for connecting a first remote trader to the trading desk; a second electronic communication device for connecting a second remote trader to the trading desk; the trading desk being generated with an electronic computing device having non-transitory computer-readable medium and at least one processor, the electronic computing device being encoded with instructions for execution by the electronic computing device, the execution of the instructions providing a method of trading comprising steps of: hosting the trading desk by a tenant and administering the trading desk by an administrator; connecting the first remote trader and the second remote trader onto the trading desk; sending market data of a tradable object to the first remote trader and the second remote trader, on the trading desk; receiving an offer to buy or sell the tradable object, from the first remote trader on the trading desk; posting the first remote trader's received offer to buy or sell the tradable object onto the trading desk; selecting the posted offer to buy or sell the tradable object, by the second remote trader on the trading desk; receiving the selection of the posted offer to buy or sell the tradable object, by the trading desk; automatically notifying the administrator of the selection of the offer to buy or sell the tradable object by the second remote trader and the identity of the first remote trader and the identity of the second remote trader, upon receiving the selection; automatically generating a peer-to-peer trading room, upon the notifying of the administrator, and opening the peer-to-peer trading room for connection by the first remote trader and the second remote trader; blocking communications in the peer-to-peer trading room, until the administrator is connected in the peer-to-peer trading room, upon connecting the administrator to the peer-to-peer trading room, unblocking and enabling communications in the peer-to-peer trading room and sending a notification to the first remote trader and the second remote trader, notifying each of their enabled communications in peer-to-peer trading room; negotiating terms of the trade of the tradable object by the first remote trader and the second remote trader, in the peer-to-peer trading room, after receipt of the notification of the enabled communications in peer-to-peer trading room, by the first remote trader and the second remote trader; monitoring and facilitating the negotiations between the first remote trader and the second remote trader, by the administrator in the peer-to-peer trading room; agreeing upon an asset type of the tradable object and terms of the trade, by the first remote trader and the second remote trader; notifying the first remote trader and the second remote trader of the agreed upon asset type and the terms of the trade, by the administrator in the peer-to-peer trading room, upon the first remote trader, the second remote trader, and the administrator being simultaneously joined and present in the peer-to-peer trading room, locking in the asset type of the tradable object that is being traded and the agreed upon terms of the trade, notifying the first remote trader and the second remote trader of the locked in asset type and the terms of the trade, by the administrator in the peer-to-peer trading room; and closing the peer-to-peer trading room.

A further aspect of the present disclosure provides a method of trading a tradable object on a trading platform, by using non-transitory computer-readable medium capable of execution by an electronic computing device, the trading platform comprising: at least one trading desk, each trading desk being operated by a tenant; and the method comprising the steps of: hosting a first trading desk by a first tenant; connecting a first remote trader to the first trading desk; sending market data and an option to request a quote of at least one tradable object to the first remote trader, to the first trading desk by the first tenant; entering a quantity of a first tradable object and choosing the option to request the quote of the first tradable object and requesting the quote of the first tradable object by the first remote trader on the first trading desk; receiving the entered quantity of the first tradable object and the requested quote, by the first tenant; sending an offer to buy or sell the first tradable object to the first remote trader, by the first tenant in response to the received requested quote; waiting a finite period of time for the first remote trader to accept or reject the sent offer to buy or sell the first tradable object; accepting or rejecting the offer to buy or sell the first tradable object, by the first remote trader on the first trading desk; filling at least a portion of the quantity of the accepted offer to buy or sell the first tradable object, by the first tenant or a second remote trader on the first trading desk, if the first remote trader accepts the offer to buy or sell the first tradable object.

### BRIEF DESCRIPTION OF THE DRAWINGS

The foregoing and other features of this disclosure will become more fully apparent from the following description and appended claims, taken in conjunction with the accompanying drawings and examples. Understanding that these drawings depict only several embodiments in accordance with the disclosure and are therefore, not to be considered limiting of its scope, the disclosure will be described with additional specificity and detail through use of the accompanying drawings.

The following figures, which are idealized, are not to scale and are intended to be merely illustrative of aspects of the present disclosure and non-limiting. In the drawings, like elements may be depicted by like reference numerals. The drawings are briefly described as follows:

FIG. 1 schematically shows an illustrative embodiment of the trading system for use by remote traders in making trades of tradable objects of the present disclosure;

FIGS. 2a and 2b schematically shows an illustrative method of trading a tradable object by remote traders of the present disclosure;

FIG. 3 schematically shows another illustrative method of trading a tradable object by remote traders of the present disclosure;

FIG. 4a shows an example page, or home page, where market data may be displayed for the traders on a trading desk;

FIG. 4b shows an illustrative electronic form that provides for the selection of an offer to buy or sell a tradable object;

FIG. 5 shows an example of a pop-up or electronic form that may be used by the traders to make an offer to buy or sell a tradable object;

FIG. 6 shows an example page that may be rendered for the traders and administrators for notification of a selected trade;

FIG. 7 shows a pop-up that may be displayed to show the administrator the identity of the traders;

FIG. 8 shows an illustrative example of a page that may be displayed to show who is in the peer-to-peer trading room and that an administrator has yet to join, thus communications in the room are blocked;

FIG. 9 shows an illustrative example of a pop-up window that may be displayed to provide for notification of the status of selected trades;

FIG. 10 shows an illustrative example of an open or unblocked peer-to-peer trading room with example negotiations by the first remote trader and the second remote trade and monitoring and facilitating by the administrator;

FIG. 11 is an illustrative example of a page that shows that the first remote trader, the second remote trader, and the administrator are all present in the peer-to-peer trading room and that an asset type of the tradable object and the agreed upon terms of the trade have been lock in;

FIG. 12 shows an illustrative example of a notification sent to the first remote trader and/or the second remote trader of the locked in asset type and the agreed upon terms of the trade made through a network different than a network of the peer-to-peer trading room;

FIG. 13 shows an illustrative page that may provide access to the negotiations of the first remote trader and the second remote trader, the monitoring and facilitating by the administrator, and the locked in asset type and the agreed upon terms of the trade, in the peer-to-peer trading room, that were recorded and saved, or archived;

FIG. 14 shows an illustrative example of a page that may provide market data and an option to request a quote;

FIG. 15 shows an example of an offer that may be sent to the trader in response to a trader's request for a quote;

FIG. 16 shows an illustrative example of a trade agreement;

FIG. 17 shows a traders wallet having a portion of their digital assets linked to the system of the present disclosure;

FIG. 18 shows a use of the linked wallet shown in FIG. 17 in the presently disclosed system; and

FIGS. 19a-19i show illustrative flow charts of steps that may be provided in the presently disclosed method and system.

### DETAILED DESCRIPTION OF THE INVENTION

The present disclosure provides a system and method for trading a tradable object. The presently disclosed method and system for trading tradable objects may provide a level of security or oversight that may increase a level of trust by the traders trading the objects. For example, currently objects are electronically traded with little or no oversight such as with direct electronic communications between the traders, for example, messaging, email, telephone, or Skype. A lack of oversight by a third party may reduce a level of trust between the traders. This lack of trust between the traders may be exemplified when one of the objects being traded is an intangible asset or object such as virtual currency. In at least one embodiment of the present disclosure, a system and method provides for an increase in oversight or security and trust of traders trading tradable objects.

Reference will now be made in detail to the present exemplary embodiments and aspects of the present invention, examples of which are illustrated in the accompanying figures.

Wherever possible, the same reference numbers may be used throughout the figures to refer to the same or like parts.

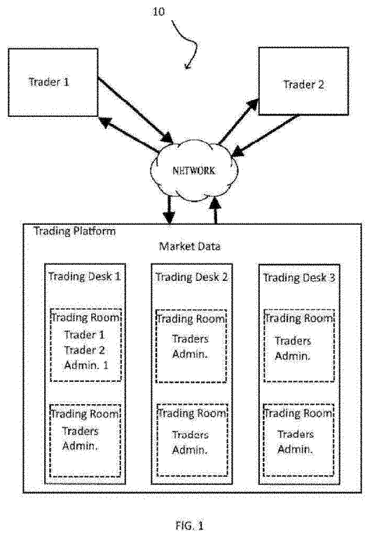

FIG. 1 schematically shows trading system 10 for use by remote traders in making trades of tradable objects. Trading system 10 has a first trader 1 and a second trader 2 each remotely connected with an electronic communication device to a trading platform through a network. The trading platform enables trader 1 and trader 2 to trade tradable objects. The trading platform is generated with an electronic computing device having non-transitory computer-readable medium and at least one processor, the electronic computing device is encoded with instructions for execution by the electronic computing device.

The trading platform may show market data related to tradable objects and host one or more tenants. Each tenant may operate a trading desk on the trading platform, for example trading desk 1, trading desk 2, and trading desk 3. Each trading desk may be hosted by a different tenant. Each tenant may have one or more administrators for administrating or monitoring and facilitating negotiations of a trade between the remote traders. Each trading desk may have a plurality of traders and a plurality of administrators. For example, administrator 1 may monitor and facilitate a trade between first remote trader 1 and second remote trader 2.

In at least one embodiment of the present disclosure, trades between trader 1 and trader 2 are monitored and facilitated by administrator 1 in a peer-to-peer trading room, as shown in FIG. 1.

Trading system 10 may be configured for use by remote traders in making trades of tradable objects. Trading system 10 may have one or more trading desks, a first electronic communication device for connecting a first remote trader to a trading desk, and a second electronic communication device for connecting a second remote trader to the trading desk. The trading desk may be generated with an electronic computing device having non-transitory computer-readable medium and at least one processor, the electronic computing device being encoded with instructions for execution by the electronic computing device, the execution of the instructions provides a method of trading.

In at least one embodiment of the present disclosure, the electronic device provides for: hosting of the trading desk by a tenant and administering the trading desk by an administrator; connecting the first remote trader and the second remote trader onto the trading desk; sending market data of a tradable object to the first remote trader and the second remote trader, on the trading desk; receiving an offer to buy or sell the tradable object, from the first remote trader on the trading desk; posting the first remote trader's received offer to buy or sell the tradable object onto the trading desk; selecting the posted offer to buy or sell the tradable object, by the second remote trader on the trading desk; receiving the selection of the posted offer to buy or sell the tradable object, by the trading desk; automatically notifying the administrator of the selection of the offer to buy or sell the tradable object by the second remote trader and the identity of the first remote trader and the identity of the second remote trader, upon receiving the selection; automatically generating a peer-to-peer trading room, upon the notifying of the administrator, and opening the peer-to-peer trading room for connection by the first remote trader and the second remote trader; blocking communications in the peer-to-peer trading room, until the administrator is connected in the peer-to-peer trading room; upon connecting the administrator to the peer-to-peer trading room, unblocking and enabling communications in the peer-to-peer trading room and sending a notification to the first remote trader and the second remote trader, notifying each of their enabled communications in peer-to-peer trading room; negotiating terms of the trade of the tradable object by the first remote trader and the second remote trader, in the peer-to-peer trading room, after receipt of the notification of the enabled communications in peer-to-peer trading room, by the first remote trader and the second remote trader; monitoring and facilitating the negotiations between the first remote trader and the second remote trader, by the administrator in the peer-to-peer trading room; agreeing upon an asset type and terms of the trade, by the first remote trader and the second remote trader; notifying the first remote trader and the second remote trader of the agreed upon asset type of the tradable object and the terms of the trade, by the administrator in the peer-to-peer trading room; upon the first remote trader, the second remote trader, and the administrator being simultaneously joined and present in the peer-to-peer trading room, locking in the asset type of the tradable object that is being traded and the agreed upon terms of the trade; notifying the first remote trader and the second remote trader of the locked in asset type and the terms of the trade, by the administrator in the peer-to-peer trading room; and closing the peer-to-peer trading room.

Trading system 10 may provide for the escrowing or holding in custody at least one of the tradable object and an asset being traded for the tradable object, by the administrator or tenant. In at least one embodiment, trading system 10 provides for escrowing or holding in custody the tradable object and the asset being traded for the tradable object, by the administrator.

Trading system 10 may be configured for notifying the first remote trader and the second remote trader through a network different than a network of the peer-to-peer trading room. In at least one embodiment, trading system 10 provides for the recording and saving, or archiving, all of the negotiations of the first remote trader and the second remote trader, the monitoring and facilitating by the administrator, and the locked in asset type and the agreed upon terms of the trade, in the peer-to-peer trading room.

The market data may be provided from a third party or may comprise the offers to buy or sell the tradable object, by the first remote trader or the second remote trader, on the trading desk. In at least one embodiment, trading system 10 is configured for sending a trade agreement to the first remote trader and the second remote trader, by the administrator upon the locking in of the asset type and the agreed upon terms of the trade and executing the trade agreement by the first remote trader and the second remote trader. For example, the traders may be electronically sent a trading agreement and the traders may electronically execute the trade agreement.

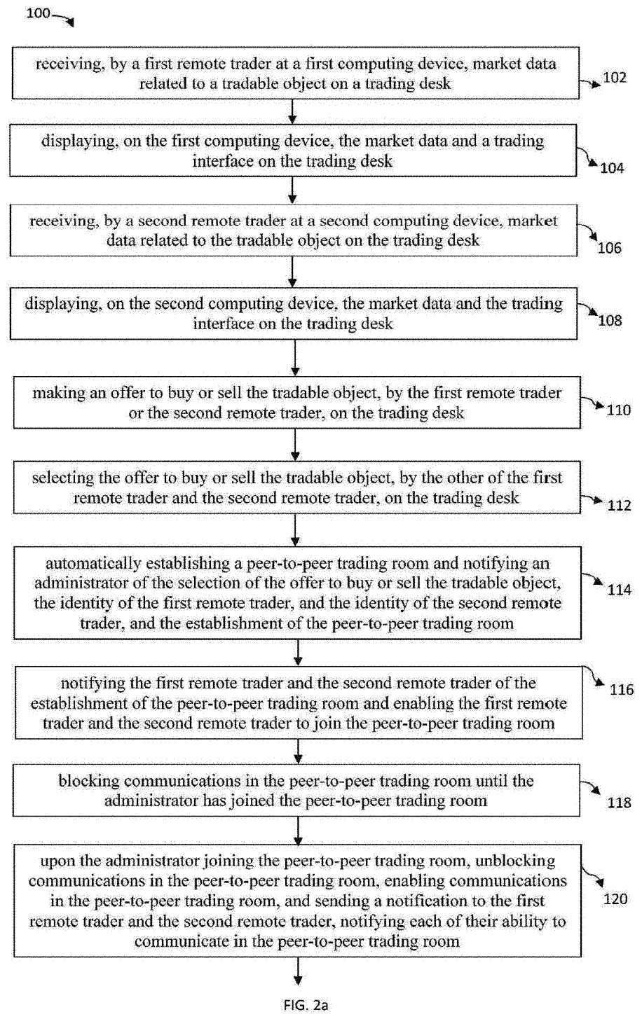

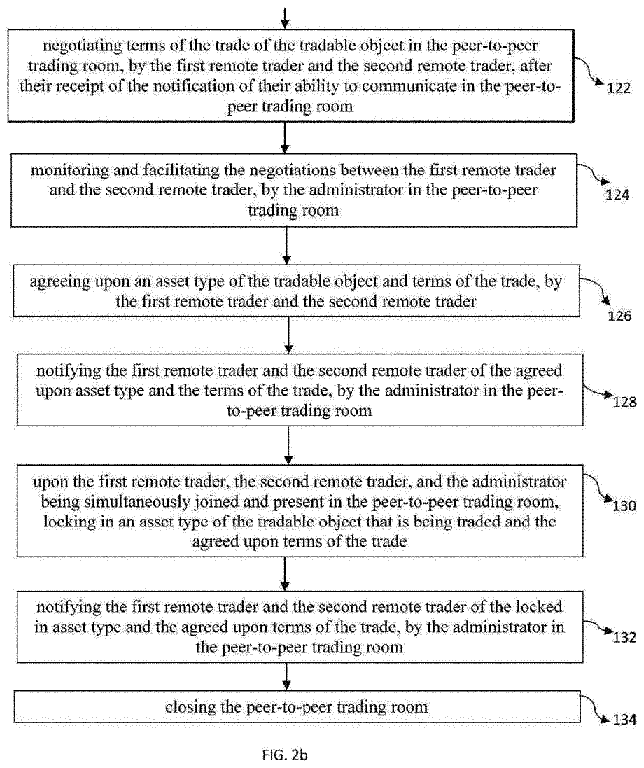

FIGS. 2a and 2b schematically shows illustrative method 100 of the trading of a tradable object by remote traders. At step 102 a first remote trader at a first computing device receives market data related to a tradable object on a trading desk and the market data and a trading interface is displayed on the first computing device for the first remote trader at step 104.

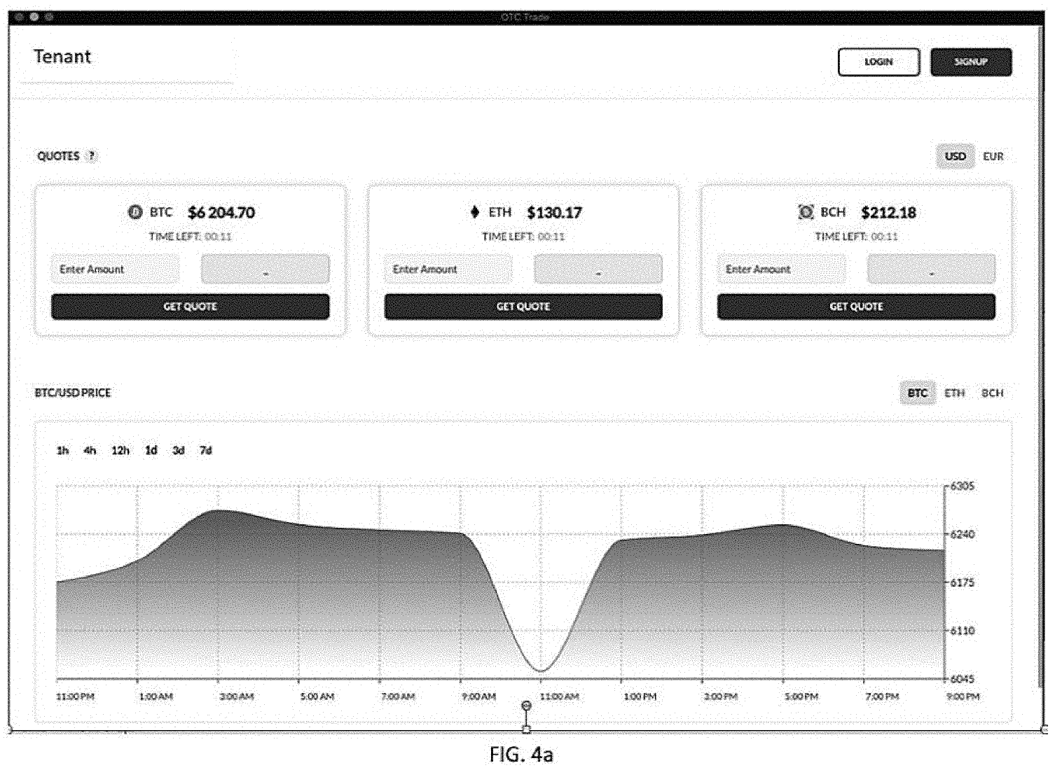

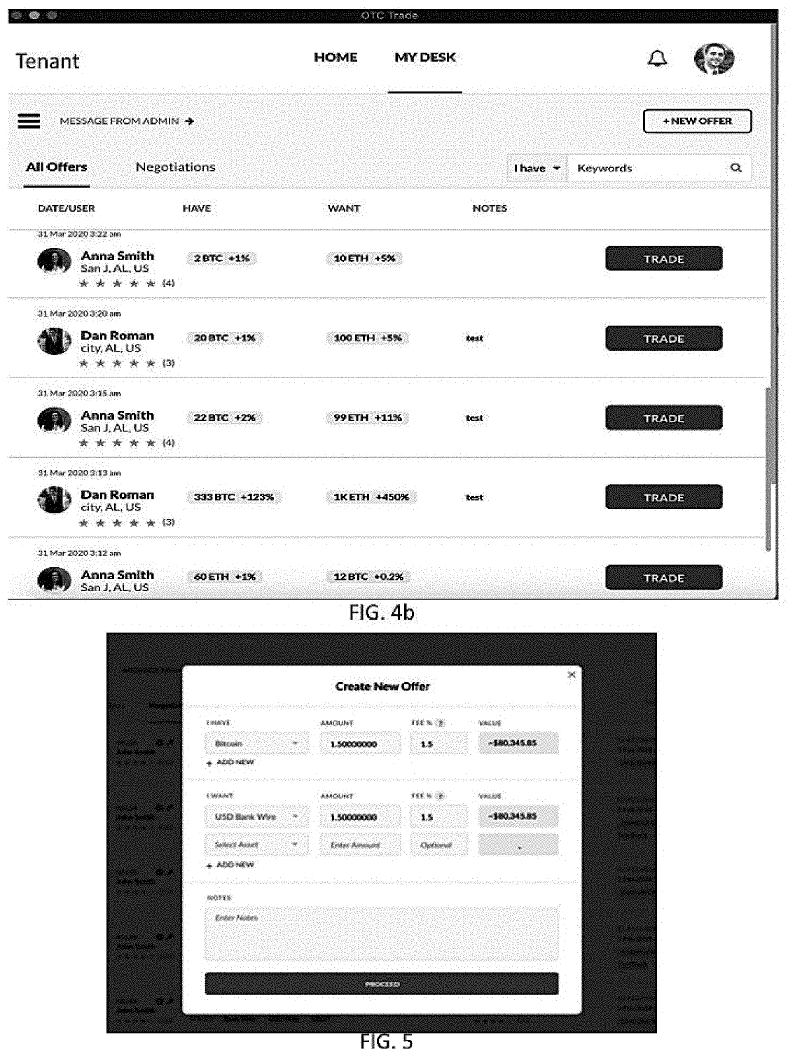

At step 106 a second remote trader at a second computing device receives the market data related to the tradable object on the trading desk and the market data and the trading interface is displayed on the second computing device for the second remote trader at step 109. FIG. 4a shows an example page, or home page, where market data may be displayed for the traders on a trading desk.

At step 110 the first remote trader or the second remote trader makes an offer to buy or sell the tradable object, on the trading desk. FIG. 5 shows an example of a pop-up or electronic form that may be used by the traders to make an offer to buy or sell a tradable object. The offer is received by the other traders on the trading desk, as shown in FIG. 4b for example. At step 112, the placed offer to buy or sell the tradable object may be selected by the other of the first remote trader and the second remote trader, on the trading desk. FIG. 4b shows an illustrative electronic form that may provide for the selection of an offer to buy or sell a tradable object. For example, a trader may simply press a trade button associated with an offer.

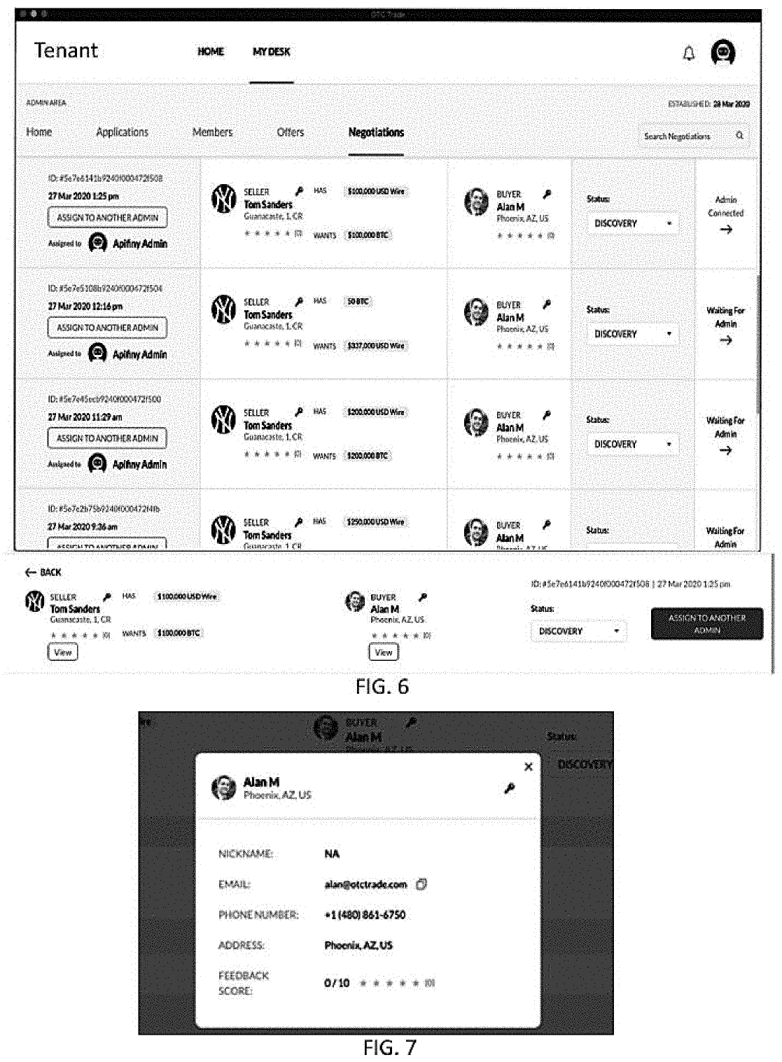

Upon making an offer by one trader and the selection of the offer by another trader, a peer-to-peer trading may be established for negotiations by the traders. For example, at step 114 a peer-to-peer trading room is automatically established for the traders. At step 116, an administrator is notified of the selection of the offer to buy or sell the tradable object, the identity of the first remote trader, the identity of the second remote trader, and the establishment of the peer-to-peer trading room. FIG. 6 shows an example page that may be rendered for the administrators for notifications of selected trades. The status of the request to trade may also be shown. For example, the status may show waiting for administrator while blocking the communications in the trading room. FIG. 7 shows a pop-up that may be displayed to show the identity of the traders to administrator(s).

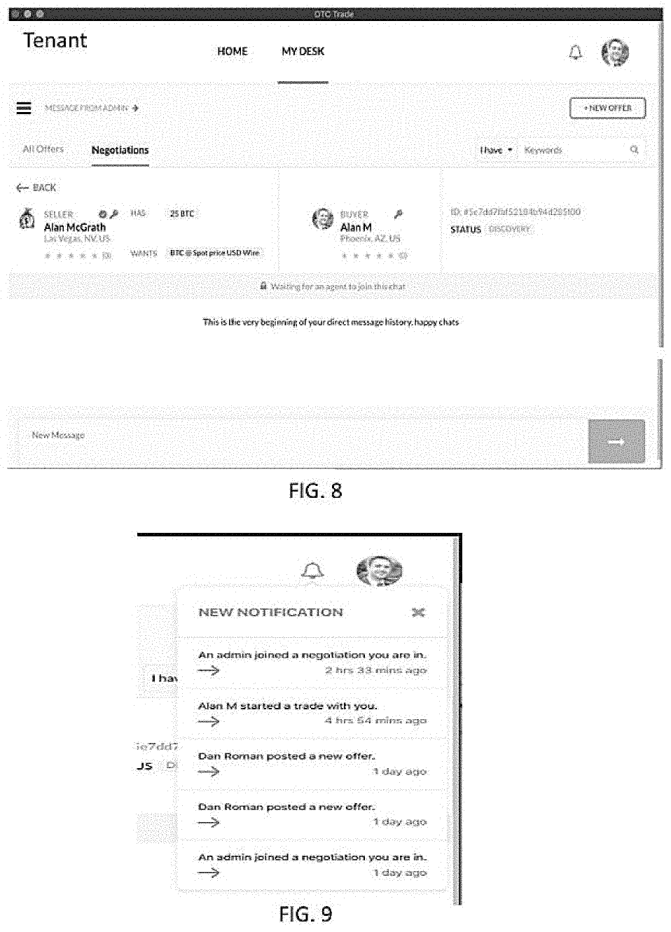

At step 118, communications in the peer-to-peer trading room may be blocked until the administrator has joined the peer-to-peer trading room. FIG. 8 shows an illustrative example of a page that may be displayed to show who is in the peer-to-peer trading room and that an administrator has yet to join, thus communications in the room are blocked.

Upon the administrator joining the peer-to-peer trading room, communications in the peer-to-peer trading room may be unblocked, enabling communications in the peer-to-peer trading room, and a notification may be sent to the first remote trader and the second remote trader, notifying each of their ability to communicate in the peer-to-peer trading room, at step 120. FIG. 9 shows an illustrative example of a pop-up window that may be displayed to provide for notification of the status of selected trades. For example, a trader may be notified that an administrator has joined one of your trading rooms or that another trader has selected an offer you have made, or an offer has been posted by another trader.

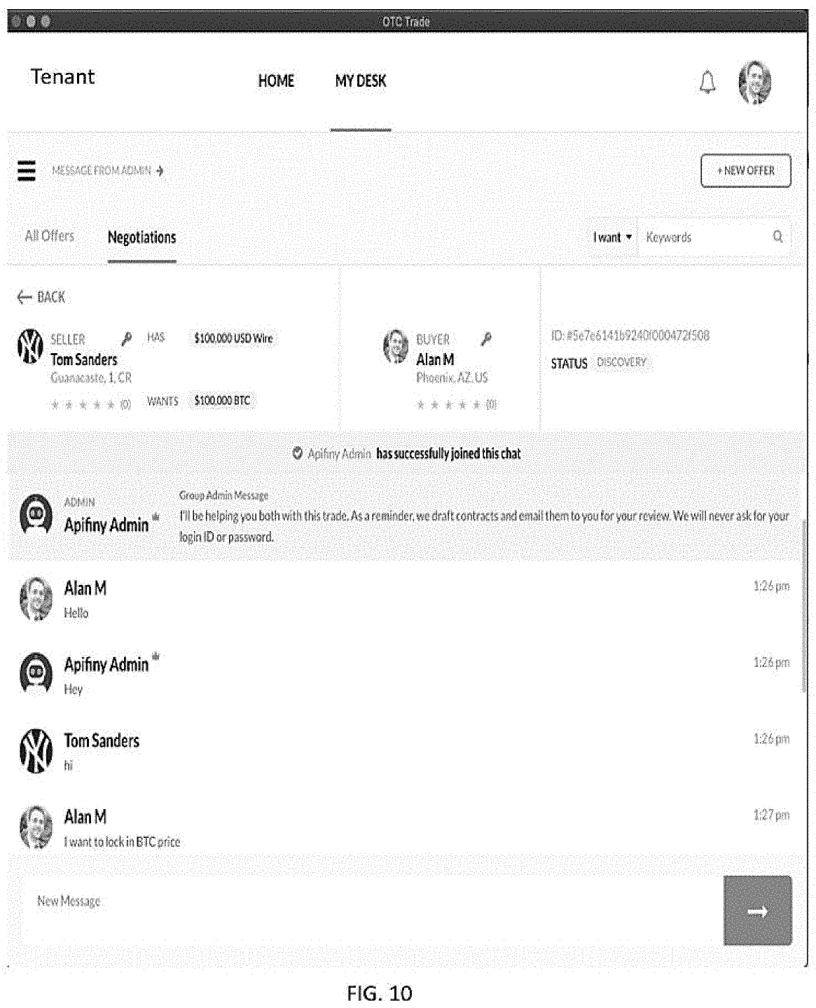

Upon unblocking communications in the peer-to-peer trading room, a notification may be sent and negotiations by the first remote trader and the second remote trade of terms of the trade of the tradable object may be made in the peer-to-peer trading room, at step 122. During trade negotiations in the peer-to-peer trading room, the administrator may monitor and facilitate the negotiations between the first remote trader and the second remote trader at step 124. Negotiations between the traders may continue and they may agree upon an asset type of the tradable object and terms of the trade at step 126. For example, FIG. 10 shows an illustrative example of an open or unblocked peer-to-peer trading room with example negotiations by the first remote trader and the second remote trade and monitoring and facilitating by the administrator.

If the first and the second remote traders reach an agreement as to the terms of the trade, the administrator may notify the first remote trader and the second remote trader of the agreed upon asset type and the terms of the trade, in the peer-to-peer trading room, at step 128. The traders may not be simultaneously present in the trading room for the negotiations and the agreement of terms of the trade.

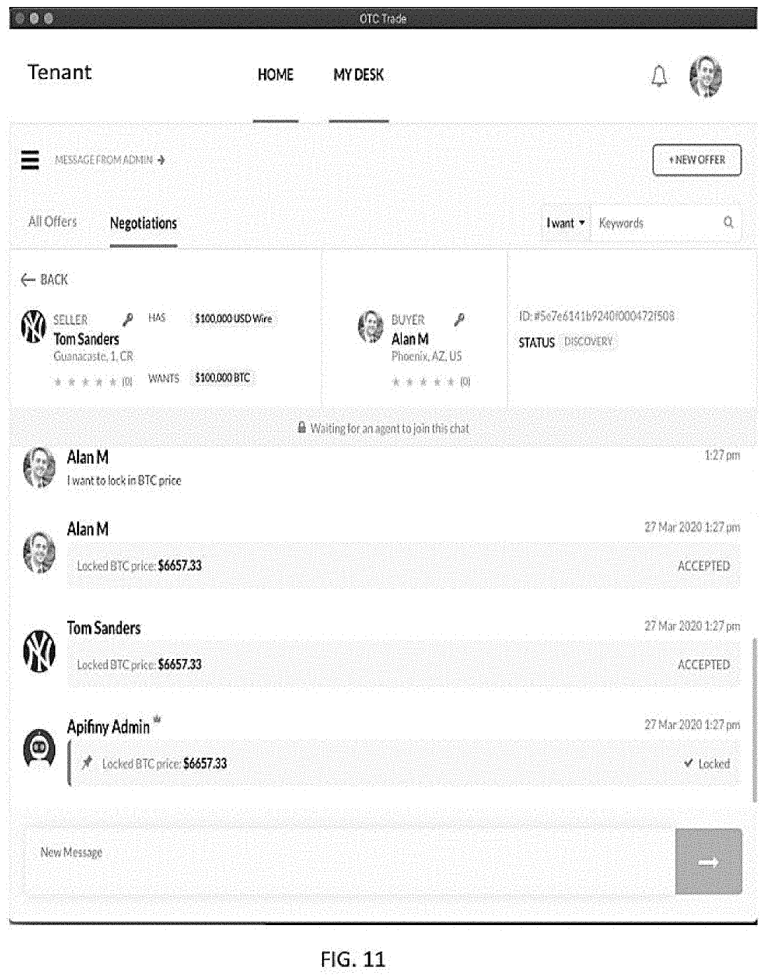

Upon the first remote trader, the second remote trader, and the administrator being simultaneously joined and present in the peer-to-peer trading room, the administrator may lock in an asset type of the tradable object that is being traded and the agreed upon terms of the trade, at step 130. The first remote trader and the second remote trader may be notified of the locked in asset type and the agreed upon terms of the trade, by the administrator in the peer-to-peer trading room, at step 132. FIG. 11 is an illustrative example of a page that shows that the first remote trader, the second remote trader, and the administrator are all present in the peer-to-peer trading room and that an asset type of the tradable object and the agreed upon terms of the trade have been lock in. Finally, the peer-to-peer trading room may be closed at step 134.

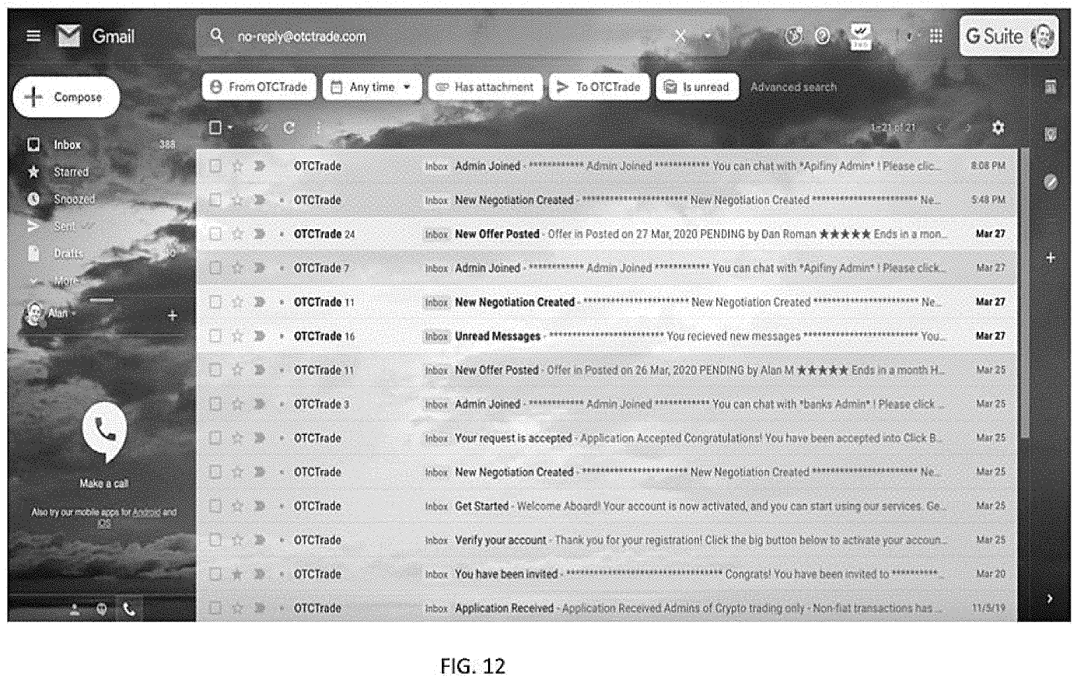

The notification sent to the first remote trader and the second remote trader of the locked in asset type and the agreed upon terms of the trade may additionally be made through a network different than a network of the peer-to-peer trading room, with email or texting for example FIG. 12 shows an illustrative example of a notification sent to the first remote trader and/or the second remote trader of the locked in asset type and the agreed upon terms of the trade made through a network different than a network of the peer-to-peer trading room, for example Gmail.

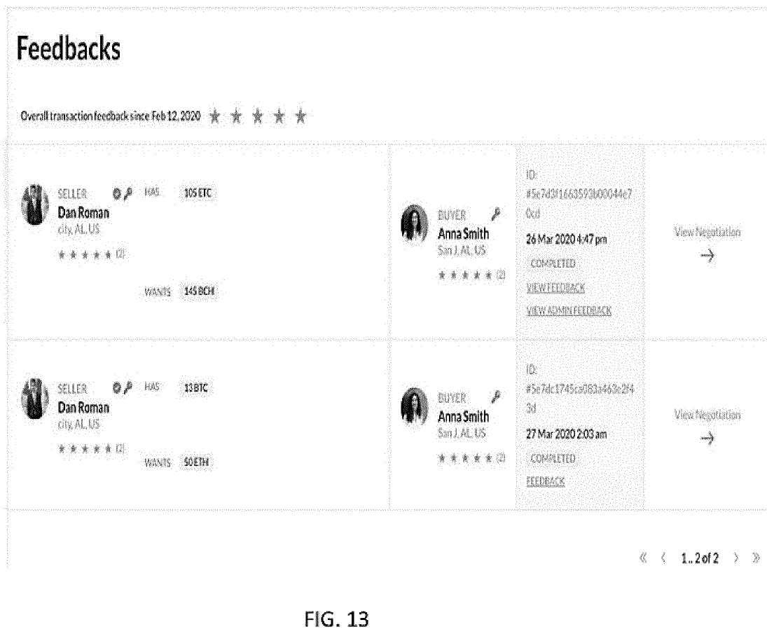

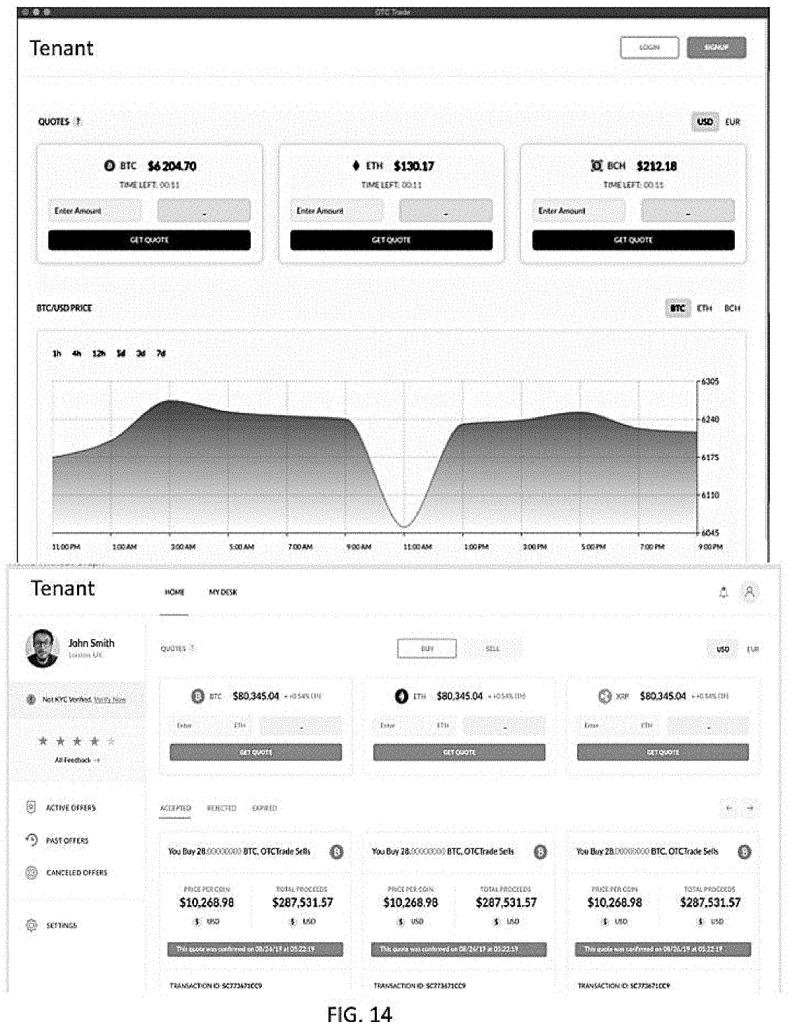

All of the negotiations of the first remote trader and the second remote trader, the monitoring and facilitating by the administrator, and the locked in asset type and the agreed upon terms of the trade, in the peer-to-peer trading room, may be recorded and saved, or archived. The first trader and the second trader may have access to the archives of the trades which they were a party too. Also, administrators and tenants of the trading rooms may also be granted access to the archived negotiations and trade agreements. FIG. 13 shows an illustrative page that may provide access to the negotiations of the first remote trader and the second remote trader, the monitoring and facilitating by the administrator, and the locked in asset type and the agreed upon terms of the trade, in the peer-to-peer trading room, that were recorded and saved, or archived.

The market data displayed on the trading desk may be sourced from a third party and/or the market data may sourced from traders on a trading platform hosting one or more tenants and one or more trading desks. For example, the market data may comprise the offers to buy or sell the tradable object, by the first remote trader or the second remote trader, on the trading desk. In at least one embodiment, an algorithm may be used to calculate market data for display to the traders. The algorithm may access trader's offers to buy or sell, third party market data providers, and/or a combination of the sources of data to compute market data for providing to the traders.

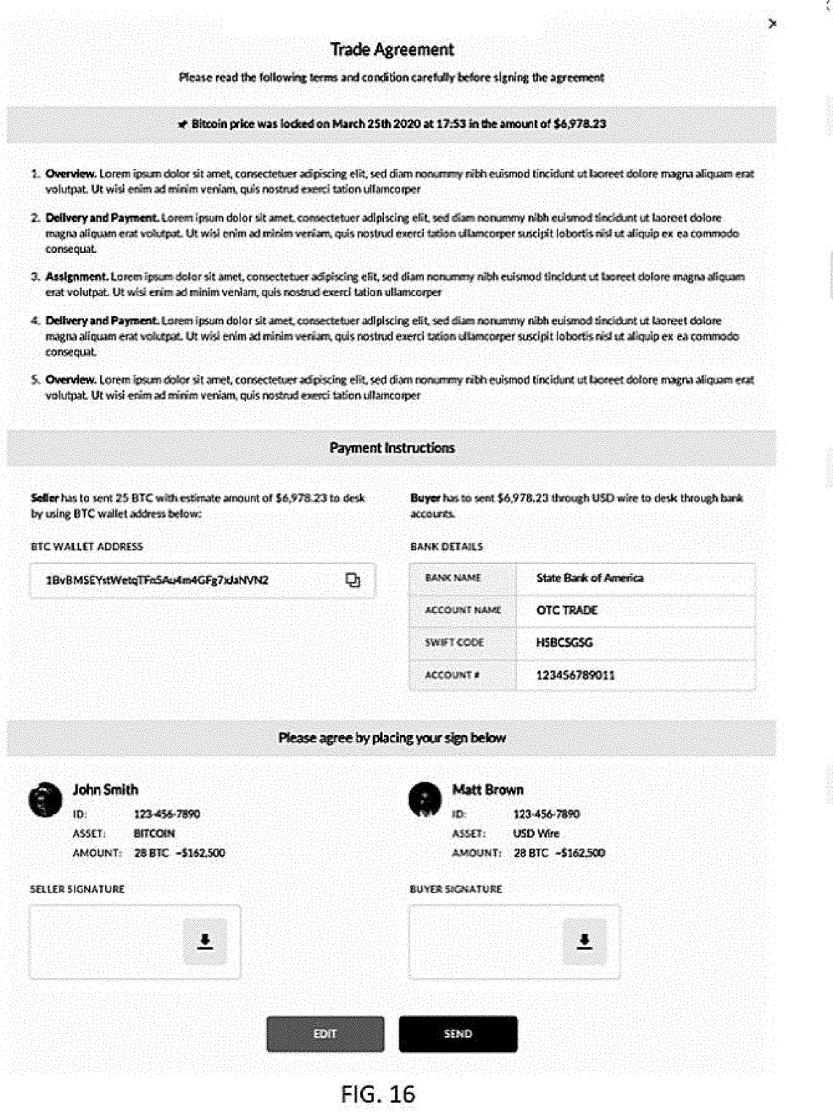

Upon locking in the asset type of the tradable object that is being traded and the agreed upon terms of the trade, an agreement may be sent to the first remote trader and the second remote trader for execution. The trade agreement may be electronically sent and executed by the first remote trader and the second remote trader. For example, a third party service or API such as DocuSign® may be used for execution of agreements. An illustrative agreement, or Trade Agreement, is shown in FIG. 16.

A tenant or administrator may escrow, or hold in custody, one or both of the tradable object and an asset being traded for the tradable object. For example, a tenant or administrator may escrow, or hold in custody, the object being traded by the first remote trader or the second remote trader. a tenant or administrator may escrow, or hold in custody, the object being traded by the first remote trader or the second remote trader.

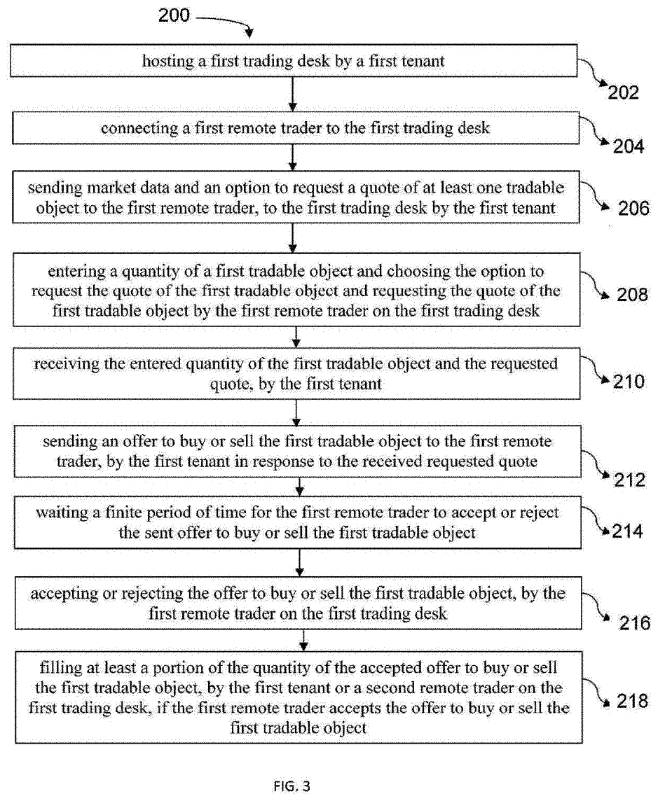

FIG. 3 schematically shows method 200 for trading a tradable object by remote traders of the present disclosure. Method 200 may be performed by hosting a trading platform, by using non-transitory computer-readable medium capable of execution by an electronic computing device. The trading platform may have at least one trading desk, wherein each trading desk may be operated by a different tenant. Each tenant may have one or more administrators facilitating trades being made on their tenants trading desk.

Method 200 may provide the hosting of a first trading desk by a first tenant at step 202 and connecting a first remote trader to the first trading desk at step 204. Market data and an option to request a quote of at least one tradable object may be sent to the first remote trader by the first tenant hosting the first trading desk at step 206. For example, FIG. 14 shows an illustrative example of a page that may provide market data and an option to request a quote to the first remote trader on the first trading desk.

The first trader may select the request for quote for a desired tradable object. For example, at step 208 the first trader may enter a desired quantity of the selected tradable object and choose the option to request the quote of the tradable object, thus requesting the quote of the first tradable object at step 208. Upon entering a quantity and requesting a quote by the first trader at step 208, the request is received by the first tenant, hosting the first trading desk, at step 210.

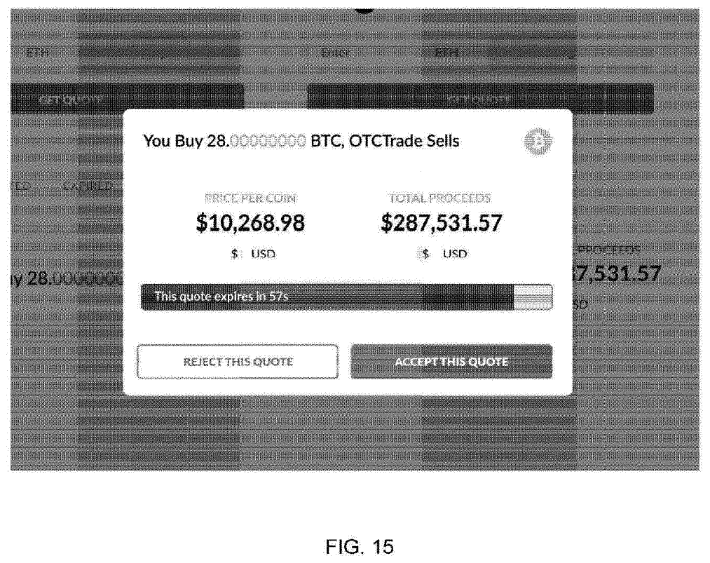

In response to the received quote request by the first tenant, the first tenant may send an offer to buy or sell at least a portion of the requested quantity of the first tradable object to the first remote trader at step 212. For example, FIG. 15 shows an example of an offer that may be sent to the trader in response to the trader's request for a quote. At step 214, the tenant may wait a finite period of time for the first remote trader to accept or reject the sent offer to buy or sell the first tradable object. Upon the expiration of the period of time, for example 5 seconds, 10 seconds, 30 seconds, or one or more minutes, the offer may expire. For example, FIG. 15 shows an example of a wait period notifying the trader of the expiration time of the offer made by the tenant.

At step 216 the first remote trader accepts or rejects the offer made by the tenant. If the first trader accepts the offer made by the first tenant, then at least a portion of the quantity of the accepted offer to buy or sell the first tradable object is filled by the first tenant or a second remote trader on the first trading desk. It is to be understood that the first tenant referred to in method 200 making the offer, may be a tenant, such as a company hosting the trading desk, an administrator, or another trader on the trading desk.

Any unfilled portion of the quantity of the requested offer, or accepted offer, to buy or sell the first tradable object may be offered to a third remote trader, if the first tenant and/or the second remote trader don't completely fill the quantity of the request or accepted offer to buy or sell the first tradable object. Any unfilled portion of the quantity of the requested offer, or accepted offer, to buy or sell the first tradable object may be offered to a to a second tenant or fourth remote trader, if the first tenant, the second remote trader, and third remote trader don't completely fill the quantity of the accepted offer to buy or sell the first tradable object.

In at least one embodiment of method 200, upon acceptance of the offer by the first trader, a trade agreement is sent to at least the first remote trader the trade agreement is executed by the first remote trader. For example, a trade agreement as the agreement shown in FIG. 16 may be sent to the first trader and may also be sent to all the parties to the trade.

In at least one embodiment of the presently disclosed system and method, at least one of the tradable object being traded and the asset being traded for the tradable object may be, but is not limited to, a cryptocurrency. A cryptocurrency wallet is a device, physical medium, program or a service which stores the public and/or private keys and can be used to track ownership, receive or spend cryptocurrencies. The cryptocurrency itself may not be in the wallet. For example, Bitcoin and cryptocurrencies derived from it, the cryptocurrency is decentrally stored in a publicly available ledger called the blockchain.

The presently disclosed system and method may provide for traders to have their wallet available on a trading desk. For example, a trader may link their wallet, or portions of their digital assets, to the trading desk. A trader may also enable a tenant to hold or take custody of one or more assets in their wallet. The trader may maintain custody of the linked asset and the linking may show the trader's ownership of the asset.

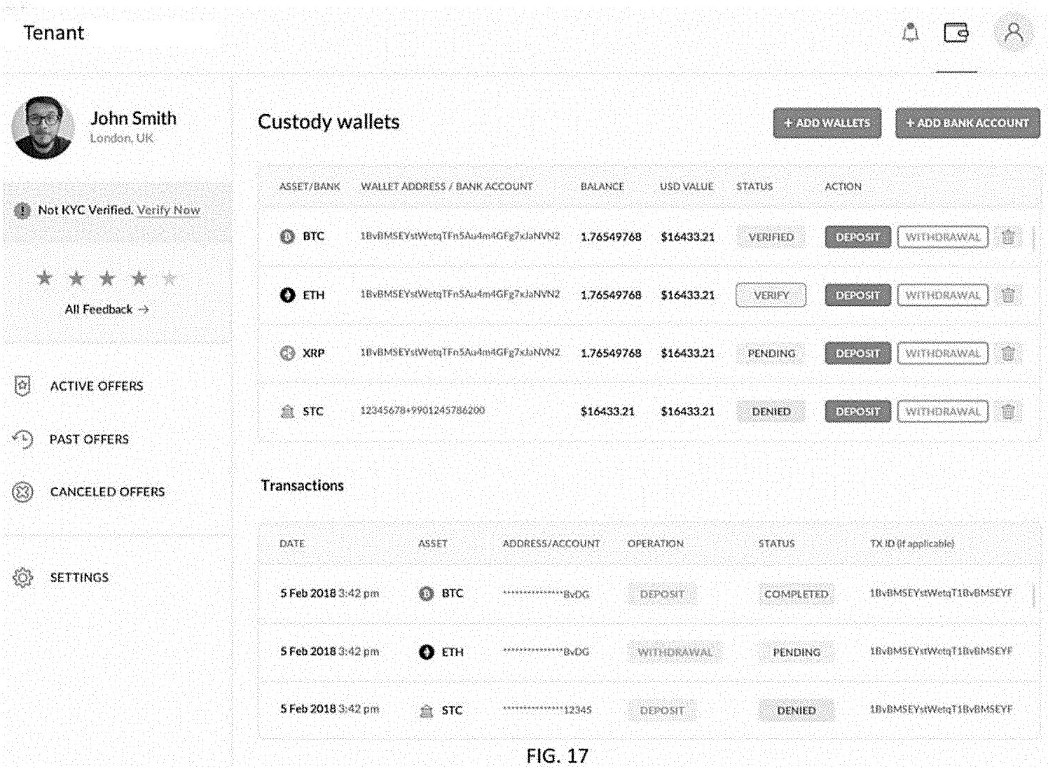

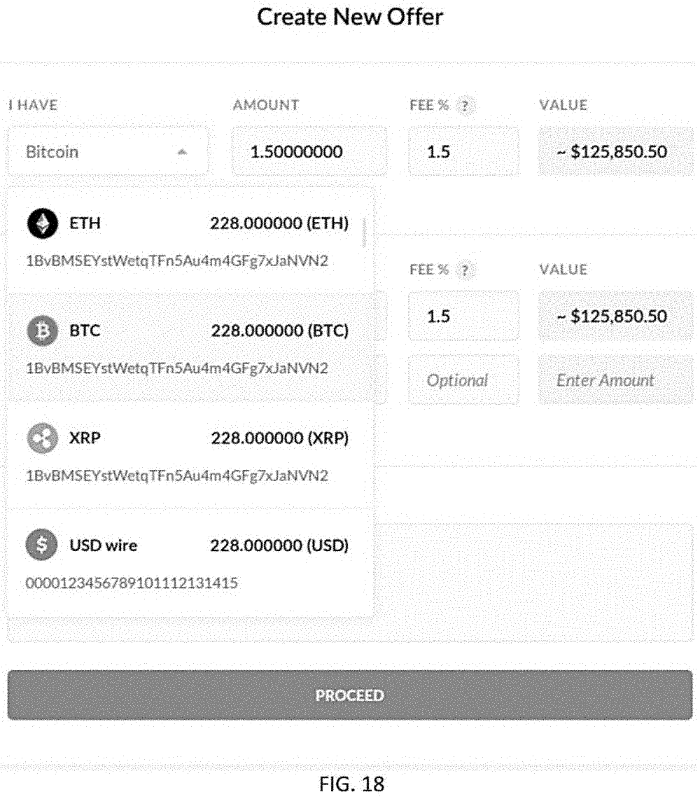

FIG. 17 shows a traders wallet having a portion of their digital assets linked to the system of the present disclosure. In at least one embodiment of the present disclosure, a trader may add a wallet for linking to the presently disclosed trading system by selecting an icon, for example “add wallet”. One or more assets in the wallet may be verified, typically by the trader's tenant or administrator. Once an electronic asset has been link to the system and verified, it may be used by the trader in the system. It is to be understood that an asset may not be required to be linked be used by the trader in the system. An example of using a linked digital asset is shown in FIG. 18. For example, as shown in FIG. 18, a trader may select a linked asset, or other asset, such as non-linked asset, when creating a new offer. Other uses of a linked asset, and non-linked assets, include, but not limited to, filling or completing a trade per the negotiated terms.

In at least one embodiment of the present disclosure, the presently disclosed system is configured to provide multi-party computation (MPC). MPC is a relatively new cryptographic method that separates private keys into multiple parts. MPC can help mitigate theft and loss of a digital asset and may be used without the blockchain knowing that it was utilized at all.

In at least one embodiment of the present disclosure, a trader of client may move their assets or funds around, such as moving to and from cold wallets, hot wallets, exchanges, other custody wallets etc. For example, MPC may be used to securely move assets around with the presently disclosed trading system. In at least one embodiment of the present disclosure, tenants are enabled to move their assets or funds around using MPC.

In at least one other embodiment of the presently disclosed system and method, a trade of an asset is locked in according to method 100, or method 200, or with system 10. The trade may be completed or filled by moving the tradable object and the asset being traded for the tradable object, ex. both trader's 1 and trader's 2 assets being traded, into custody with the tenant hosting the trading desk. Upon both trader's 1 asset and trader's 2 asset being moved into the tenant's escrow, the tenant may release the assets to the traders according to the terms of the trade and close or fill the trade. In at least one embodiment, a smart contract may be used to execute or complete the trade. A smart contract is a computer protocol intended to digitally facilitate, verify, or enforce the negotiation or performance of a contract. Smart contracts may allow the performance of transactions without third parties. With a smart contract, the transactions may be trackable and irreversible. System 10 may be configured to use MPC in carrying out the trade and/or the closing of the trade.

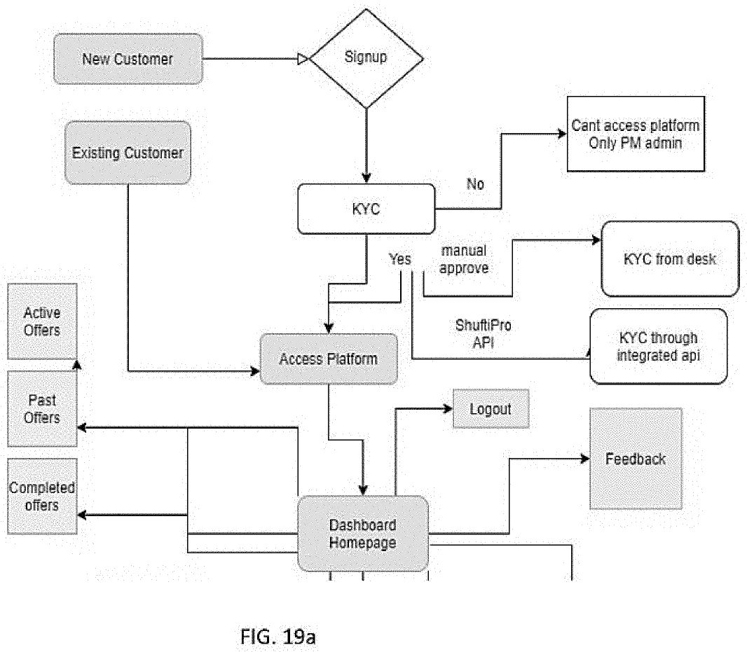

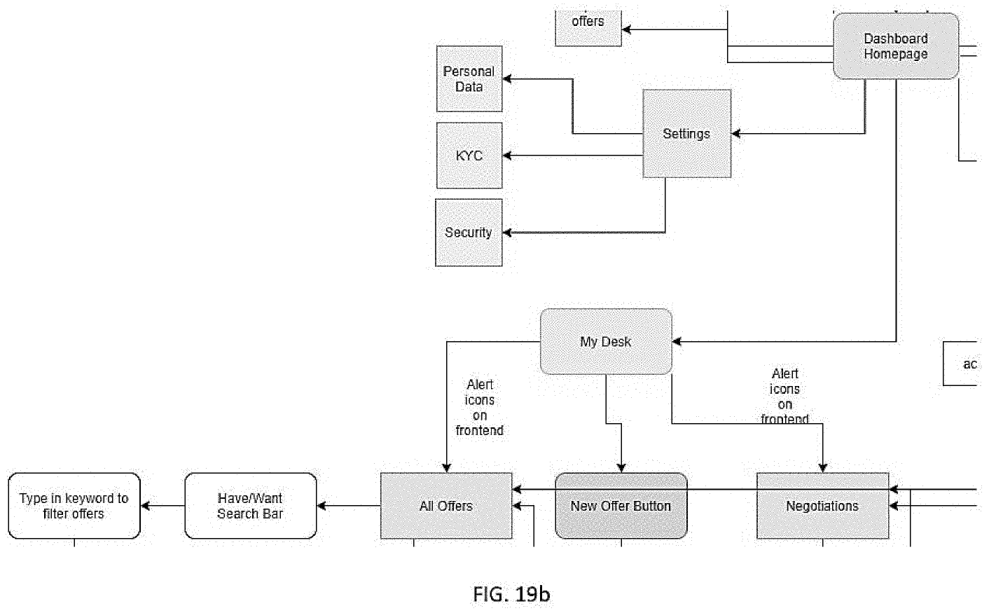

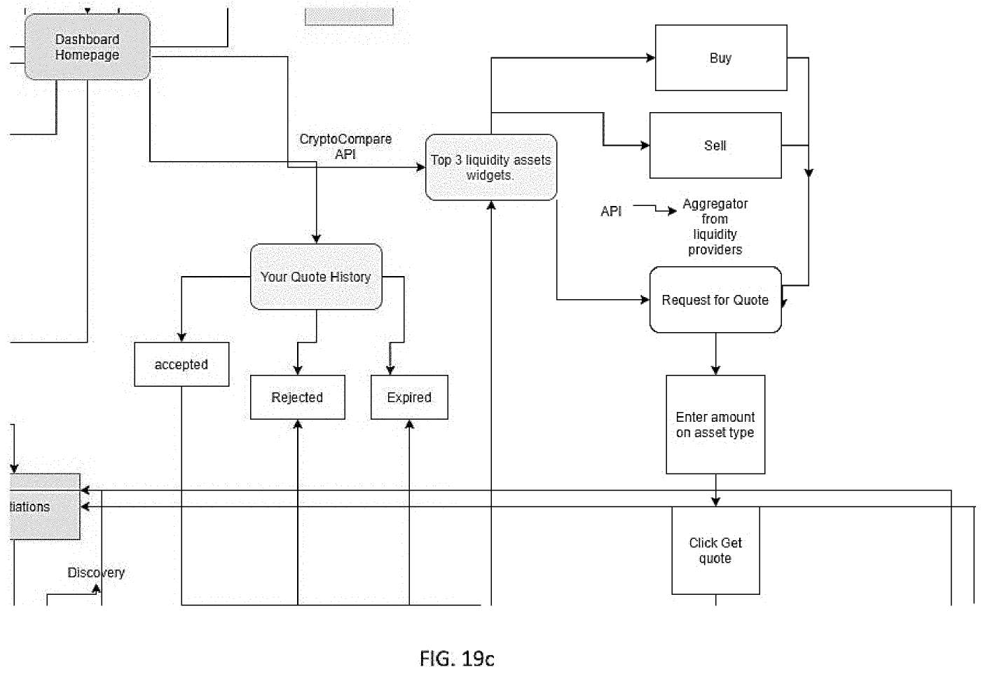

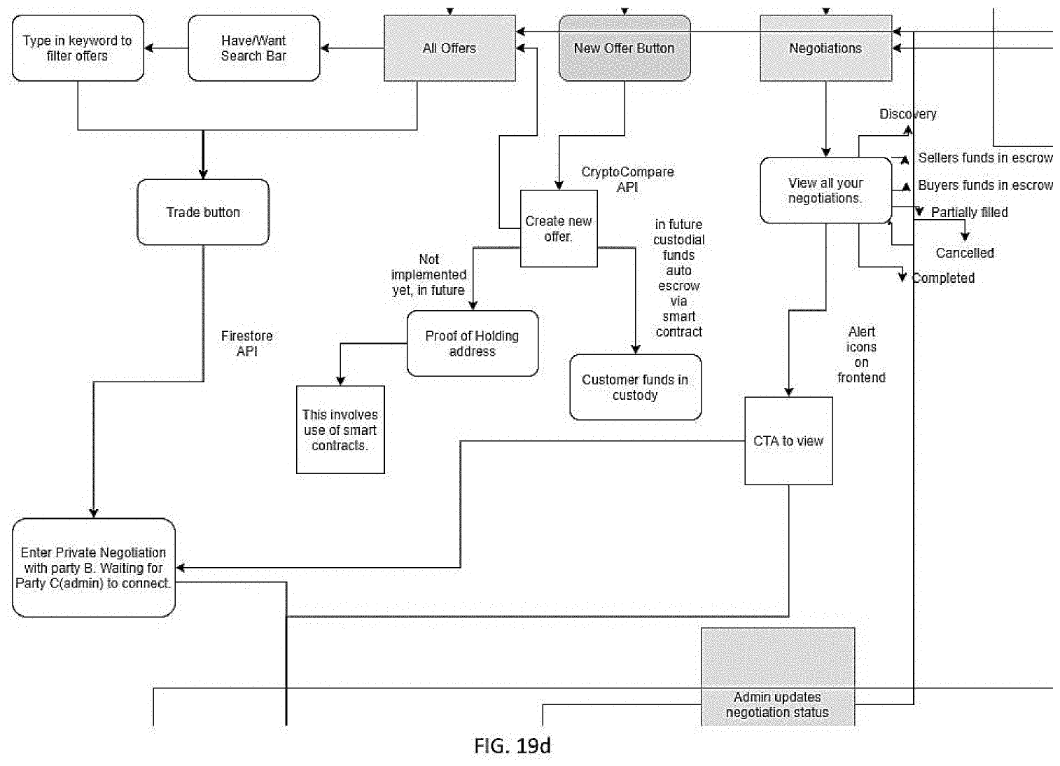

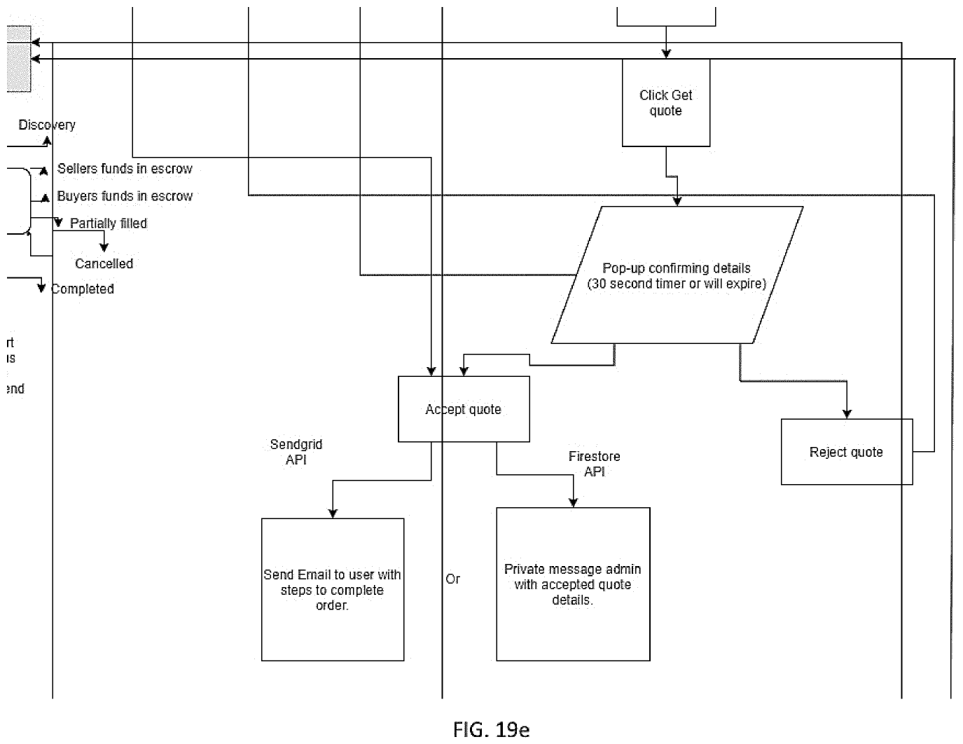

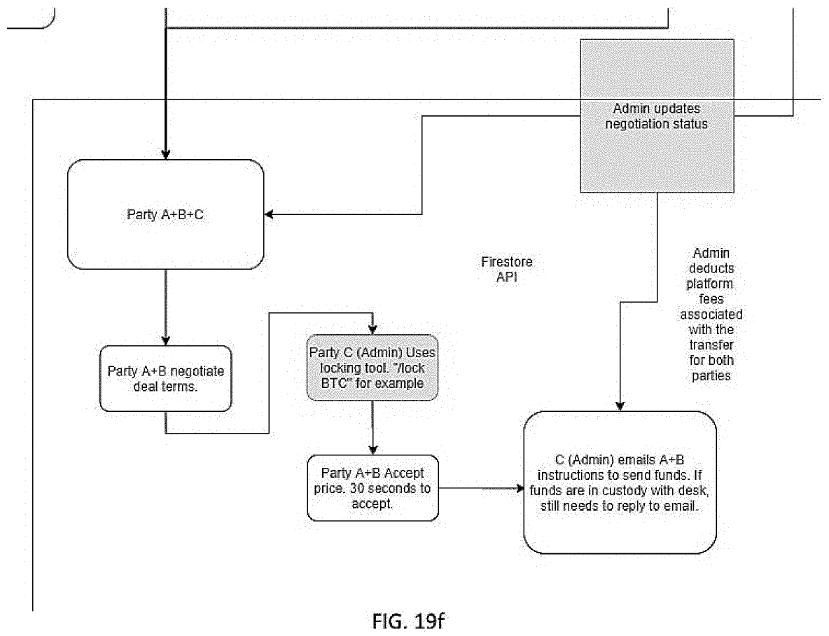

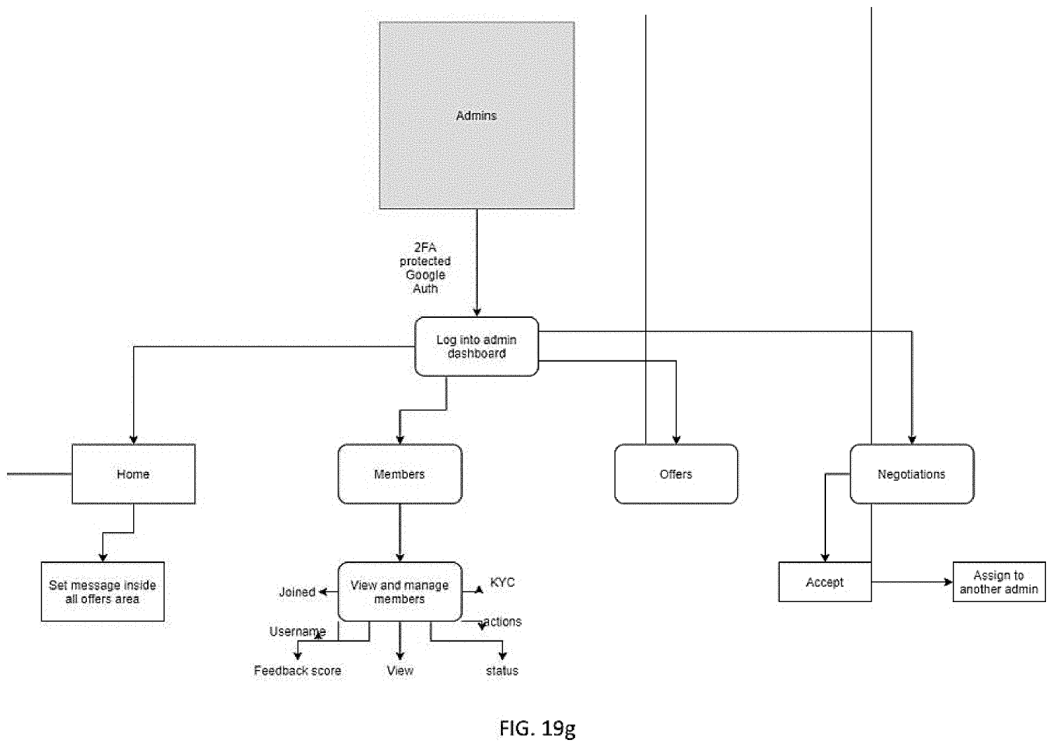

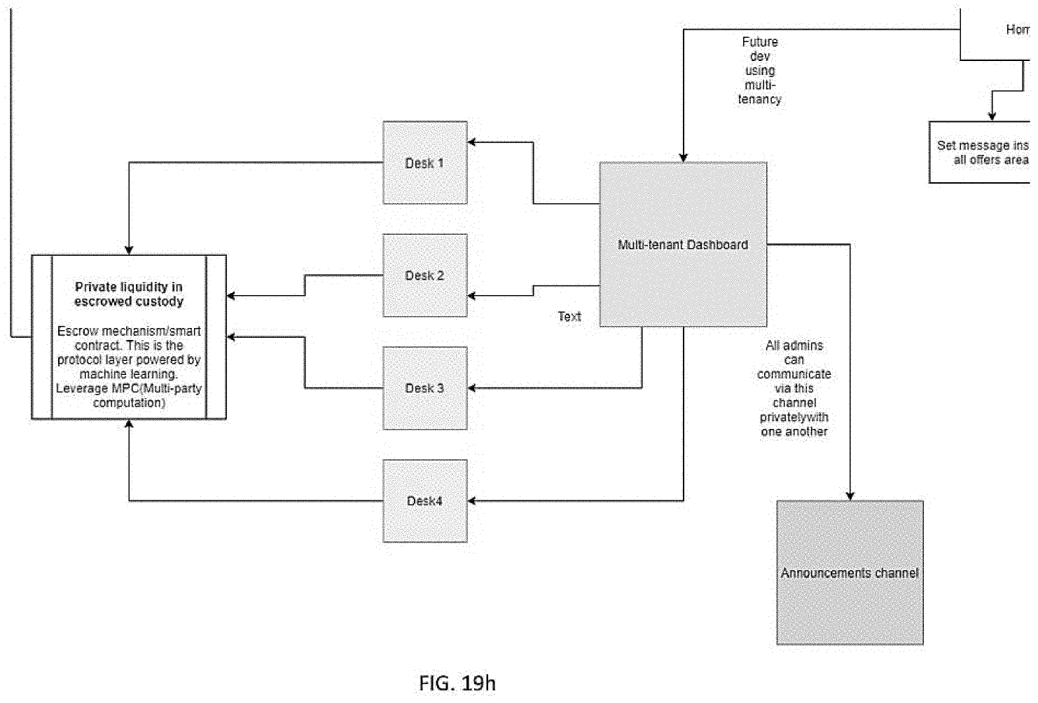

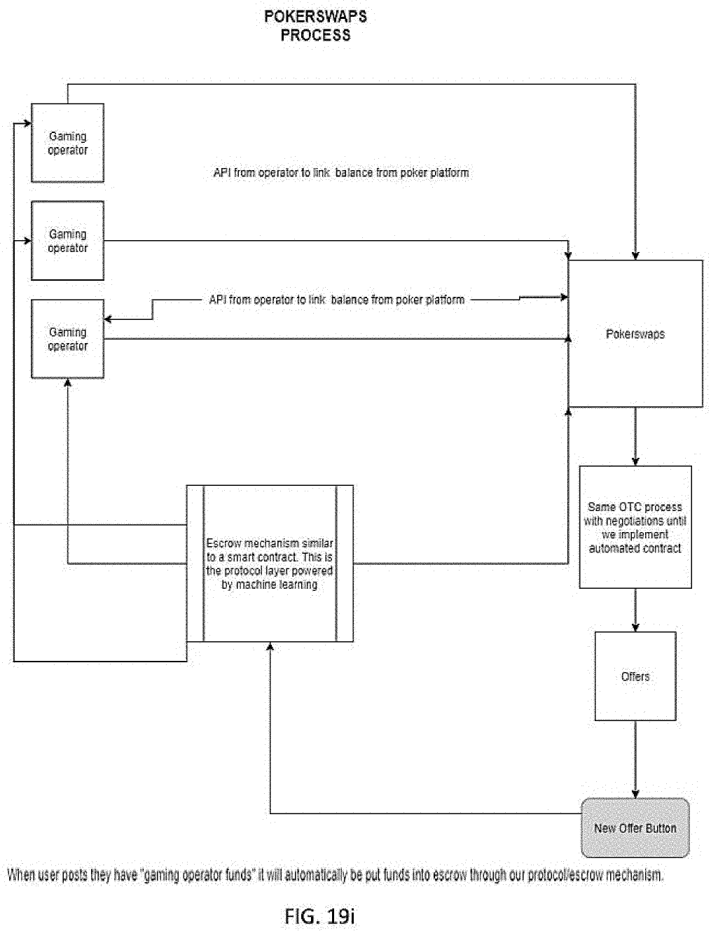

FIGS. 19a-19h show an illustrative flow chart of steps that may be included in one or more embodiments of the presently disclosed method and system. For example, the presently disclosed method and system may begin at FIG. 19a showing a flow a flow of steps for a trader to sign up, or to sign in, including know your customer (KYC) steps that may be taken. FIGS. 19b and 19h show options that may be provided to a user from their dashboard home page. FIG. 19h shows a plurality of trading desks, wherein one or more of the trading desks may have one or more peer-to-peer trading rooms and administrators, such as schematically shown in FIG. 1. FIG. 19i shows an example flow chart of a gaming operator's, for example Pokerswaps, implementation of the presently disclosed system and method for trading. For example, Pokerswaps may operate as a tenant on the presently disclosed system and/or may implement method 100 or method 200.

It is to be understood that the tradable objects and the items or assets being traded for the objects, under the terms of the trade may be tangible or intangible goods or services. For example, the tradable objects and the items or assets being traded for the objects may include fiat such as USD or other legal tender whose value is backed by the government that issued it, stocks, bonds, gold, diamonds, other commodities, real estate, virtual currencies, cryptocurrencies, central bank digital currency, digital currencies such as Bitcoin (BTC), Bitcoin cash (BCH), Ethereum (ETH), Skrill, Binance, Dogecoin, Dash, NEO, Monero, Litecoin, America's Card Room currency (ACR dollars), Party Poker currency (Party Poker dollars), or other operators, or gaming operators, that may provide currency for trading. For example, for trading on a platform or trading desk, such as peer-to-peer trading.

It will be understood that the examples of patents, published patent applications, and other documents which are included below in this application and which are referred to in paragraphs which state “Some examples of . . . which may possibly be used in at least one possible embodiment of the present application . . . ” may possibly not be used or useable in any one or more embodiments of the application. These references, or portions thereof, are hereby incorporated by reference herein. The purpose of incorporating U.S. patents, foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

Some examples of methods and systems for trading a tradable object and other features which may possibly be utilizable by at least one possible embodiment may possibly be found in the following: U.S. patent Ser. No. 10/031,648, having inventor Weiss, et al.; U.S. patent Ser. No. 10/102,576, having inventor Lane et al.; U.S. patent Ser. No. 10/460,386, having inventor Mylet et al., U.S. patent Ser. No. 10/552,908, having inventor Pechenik, et al.; U.S. patent Ser. No. 8/799,143, having inventor Lane et al.; U.S. patent Ser. No. 9/058,628, having inventor Malackowski et al., U.S. patent Ser. No. 9/483,884, having inventor Chen, et al.; US Patent Pub. 2011/0066540, having inventor Madle et al.; US Patent Pub. 2015/0262139, having inventor Shtylman, US Patent Pub. 2016/0012532, having inventor Olson et al.; US Patent Pub. 2017/0039650, having inventor Khan et al., and US Patent Pub. 2017/0148094, having inventor Madle et al.

1. A method of trading a tradable object by using non-transitory computer-readable medium capable of execution by an electronic computing device, the method comprising the steps of:
receiving, by a first remote trader at a first computing device, market data related to a tradable object on a trading desk;
displaying, on the first computing device, the market data and a trading interface on the trading desk;
receiving, by a second remote trader at a second computing device, market data related to the tradable object on the trading desk;
displaying, on the second computing device, the market data and the trading interface on the trading desk;
making an offer to buy or sell the tradable object, by the first remote trader or the second remote trader, on the trading desk,
selecting the offer to buy or sell the tradable object, by the other of the first remote trader and the second remote trader, on the trading desk;
automatically establishing a peer-to-peer trading room and notifying an administrator of the selection of the offer to buy or sell the tradable object, the identity of the first remote trader, the identity of the second remote trader, and the establishment of the peer-to-peer trading room;
notifying the first remote trader and the second remote trader of the establishment of the peer-to-peer trading room and enabling the first remote trader and the second remote trader to join the peer-to-peer trading room;
blocking communications in the peer-to-peer trading room until the administrator has joined the peer-to-peer trading room;
upon the administrator joining the peer-to-peer trading room, unblocking communications in the peer-to-peer trading room, enabling communications in the peer-to-peer trading room, and sending a notification to the first remote trader and the second remote trader, notifying each of their ability to communicate in the peer-to-peer trading room;
negotiating terms of the trade of the tradable object in the peer-to-peer trading room, by the first remote trader and the second remote trader, after their receipt of the notification of their ability to communicate in the peer-to-peer trading room;
monitoring and facilitating the negotiations between the first remote trader and the second remote trader, by the administrator in the peer-to-peer trading room;
agreeing upon an asset type of the tradable object and terms of the trade, by the first remote trader and the second remote trader;
notifying the first remote trader and the second remote trader of the agreed upon asset type and the terms of the trade, by the administrator in the peer-to-peer trading room;
upon the first remote trader, the second remote trader, and the administrator being simultaneously joined and present in the peer-to-peer trading room, locking in an asset type of the tradable object that is being traded and the agreed upon terms of the trade;
notifying the first remote trader and the second remote trader of the locked in asset type and the agreed upon terms of the trade, by the administrator in the peer-to-peer trading room; and
closing the peer-to-peer trading room.

2. The method of trading a tradable object of claim 1, wherein the step of notifying the first remote trader and the second remote trader of the locked in asset type and the agreed upon terms of the trade further comprises notifying the first remote trader and the second remote trader through a network different than a network of the peer-to-peer trading room.

3. The method of trading a tradable object of claim 1, further comprising recording and saving, or archiving, all of the negotiations of the first remote trader and the second remote trader, the monitoring and facilitating by the administrator, and the locked in asset type and the agreed upon terms of the trade, in the peer-to-peer trading room.

4. The method of trading a tradable object of claim 1, wherein the market data comprises the offers to buy or sell the tradable object, by the first remote trader or the second remote trader, on the trading desk.

5. The method of trading a tradable object of claim 1, further comprising the steps of:
sending a trade agreement to the first remote trader and the second remote trader, by the administrator upon the locking in of the asset type and the agreed upon terms of the trade; and
executing the trade agreement by the first remote trader and the second remote trader.

6. The method of trading a tradable object of claim 5, wherein the sending of the trade agreement and the executing of the trade agreement by the first remote trader and the second remote trader are both performed electronically.

7. The method of trading a tradable object of claim 1 further comprising escrowing, or holding in custody, at least one of the tradable object and an asset being traded for the tradable object, by the administrator.

8. The method of trading a tradable object of claim 1, further comprising linking a wallet showing ownership or custody of at least one of the tradable object and the asset being traded for the tradable object, owned by at least one of the first remote trader and the second remote trader;

9. A trading system for use by remote traders in making trades of tradable objects, the trading system comprising:
a trading desk;
a first electronic communication device for connecting a first remote trader to the trading desk;
a second electronic communication device for connecting a second remote trader to the trading desk;
the trading desk being generated with an electronic computing device having non-transitory computer-readable medium and at least one processor, the electronic computing device being encoded with instructions for execution by the electronic computing device, the execution of the instructions providing a method of trading comprising steps of:
hosting the trading desk by a tenant and administering the trading desk by an administrator;
connecting the first remote trader and the second remote trader onto the trading desk;
sending market data of a tradable object to the first remote trader and the second remote trader, on the trading desk;
receiving an offer to buy or sell the tradable object, from the first remote trader on the trading desk;
posting the first remote trader's received offer to buy or sell the tradable object onto the trading desk;
selecting the posted offer to buy or sell the tradable object, by the second remote trader on the trading desk;
receiving the selection of the posted offer to buy or sell the tradable object, by the trading desk;
automatically notifying the administrator of the selection of the offer to buy or sell the tradable object by the second remote trader and the identity of the first remote trader and the identity of the second remote trader, upon receiving the selection;
automatically generating a peer-to-peer trading room, upon the notifying of the administrator, and opening the peer-to-peer trading room for connection by the first remote trader and the second remote trader;
blocking communications in the peer-to-peer trading room, until the administrator is connected in the peer-to-peer trading room;
upon connecting the administrator to the peer-to-peer trading room, unblocking and enabling communications in the peer-to-peer trading room and sending a notification to the first remote trader and the second remote trader, notifying each of their enabled communications in peer-to-peer trading room;
negotiating terms of the trade of the tradable object by the first remote trader and the second remote trader, in the peer-to-peer trading room, after receipt of the notification of the enabled communications in peer-to-peer trading room, by the first remote trader and the second remote trader;
monitoring and facilitating the negotiations between the first remote trader and the second remote trader, by the administrator in the peer-to-peer trading room;
agreeing upon an asset type and terms of the trade, by the first remote trader and the second remote trader;
notifying the first remote trader and the second remote trader of the agreed upon asset type of the tradable object and the terms of the trade, by the administrator in the peer-to-peer trading room;
upon the first remote trader, the second remote trader, and the administrator being simultaneously joined and present in the peer-to-peer trading room, locking in the asset type of the tradable object that is being traded and the agreed upon terms of the trade;
notifying the first remote trader and the second remote trader of the locked in asset type and the terms of the trade, by the administrator in the peer-to-peer trading room; and
closing the peer-to-peer trading room.

10. The trading system of claim 9, wherein the execution of the instructions comprises escrowing or holding in custody at least one of the tradable object and an asset being traded for the tradable object, by the administrator.

11. The trading system of claim 10, wherein the execution of the instructions comprises escrowing or holding in custody the tradable object and the asset being traded for the tradable object, by the administrator.

12. The trading system of claim 10, wherein the execution of the instructions comprises notifying the first remote trader and the second remote trader through a network different than a network of the peer-to-peer trading room.

13. The trading system of claim 10, wherein the execution of the instructions comprises recording and saving, or archiving, all of the negotiations of the first remote trader and the second remote trader, the monitoring and facilitating by the administrator, and the locked in asset type and the agreed upon terms of the trade, in the peer-to-peer trading room.

14. The trading system of claim 10, wherein the market data comprises the offers to buy or sell the tradable object, by the first remote trader or the second remote trader, on the trading desk.

15. The trading system of claim 10, wherein the execution of the instructions comprises:
sending a trade agreement to the first remote trader and the second remote trader, by the administrator upon the locking in of the asset type and the agreed upon terms of the trade; and
executing the trade agreement by the first remote trader and the second remote trader.

16. The trading system of claim 15, wherein the execution of the instructions comprises electronically sending of the trade agreement and electronically executing of the trade agreement by the first remote trader and the second remote trader.

17. A method of trading a tradable object on a trading platform, by using non-transitory computer-readable medium capable of execution by an electronic computing device, the trading platform comprising:
at least one trading desk, each trading desk being operated by a tenant; and
the method comprising the steps of:
hosting a first trading desk by a first tenant;
connecting a first remote trader to the first trading desk;
sending market data and an option to request a quote of at least one tradable object to the first remote trader, to the first trading desk by the first tenant;
entering a quantity of a first tradable object and choosing the option to request the quote of the first tradable object and requesting the quote of the first tradable object by the first remote trader on the first trading desk;
receiving the entered quantity of the first tradable object and the requested quote, by the first tenant;
sending an offer to buy or sell the first tradable object to the first remote trader, by the first tenant in response to the received requested quote;
waiting a finite period of time for the first remote trader to accept or reject the sent offer to buy or sell the first tradable object;
accepting or rejecting the offer to buy or sell the first tradable object, by the first remote trader on the first trading desk; and
filling at least a portion of the quantity of the accepted offer to buy or sell the first tradable object, by the first tenant or a second remote trader on the first trading desk, if the first remote trader accepts the offer to buy or sell the first tradable object.

18. The method of trading a tradable object on a trading platform of claim 17 further comprising offering an unfilled portion of the quantity of the accepted offer to buy or sell the first tradable object to a third remote trader, if the first tenant or the second remote trader don't completely fill the quantity of the accepted offer to buy or sell the first tradable object.

19. The method of trading a tradable object on a trading platform of claim 18 further comprising offering an unfilled portion of the quantity of the accepted offer to buy or sell the first tradable object to a second tenant or fourth remote trader, if the first tenant, the second remote trader, and third remote trader don't completely fill the quantity of the accepted offer to buy or sell the first tradable object.

20. The method of trading a tradable object on a trading platform of claim 17 further comprising sending a trade agreement to at least the first remote trader and executing the trade agreement by the first remote trader.
